(19) United States
(12) Patent Application Publication
(10) Pub. No.: US 2013/0094806 A1
(43) Pub. Date: Apr. 18, 2013

(54) OPTICAL SIGNAL CONVERSION METHOD AND APPARATUS

(71) Applicants: Stephane LESSARD, Mirabel (CA); Martin JULIEN, Laval (CA); Robert BRUNNER, Montreal (CA)

(72) Inventors: Stephane LESSARD, Mirabel (CA); Martin JULIEN, Laval (CA); Robert BRUNNER, Montreal (CA)

(73) Assignee: TELEFONAKTIEBOLAGET L M ERICSSON (PUBL), Stockholm (SE)

(21) Appl. No.: 13/271,735

(22) Filed: Oct. 12, 2011

(51) Int. Cl. G02B 6/14

(52) U.S. Cl. 385/28

(57) ABSTRACT

An optical adapter includes an optical coupler, a plurality of fiber optic cables and an optical wavelength conversion device. The optical coupler is operable to receive a plurality of multi-mode single-wavelength optical signals having the same frequency. The plurality of fiber optic cables are arranged in parallel and each have a first end connected to the optical coupler and the other end is coupled to the optical wavelength conversion device. The optical wavelength conversion device is operable to optically convert between the plurality of multi-mode single-wavelength optical signals at the same frequency and a plurality of single-mode optical signals at different frequencies and multiplex the plurality of single-mode optical signals at the different frequencies onto a single-mode multi-wavelength optical waveguide. A corresponding optical adapter is provided for the receive side.

### TECHNICAL FIELD

The present application relates to optical signal conversion, in particular optical conversion between multi-mode single-wavelength signals and a single-mode multi-wavelength signal.

### BACKGROUND

Parallel optical short-reach interconnects (OSRI) are typically used for high-performance computing (HPC) and data center interconnects. Short reach interconnects such as OSRI are typically less than 300 m in length. Long reach interconnects are typically greater than several km in length. To send traffic over a long haul (e.g. 10 km or more), a full electrical conversion of the outgoing signal is conventionally performed in order to ensure the signal conforms to the telecom transport equipment optical characteristics between the systems. Energy is consumed converting an optical signal (such as a short reach parallel optical signal) into another form (such as a long reach serial optical signal) by an interim electrical representation. Coarse and dense wavelength division multiplexing (WDM) are other technologies which are widely used for optically transporting data. Converting between e.g. OSRI and WDM conventionally requires optical-to-electrical-to-optical conversion. In each case, the energy consumed performing such conversion is essentially wasted energy. In addition, the additional circuitry needed to perform electro-optical conversion adds to overall system cost.

### SUMMARY

Embodiments described herein relate to a system designed to use parallel optics short reach interconnects and map the various channels in an adaptable and predictable manner over different wavelengths. The system can be designed using low-cost parallel-photonic components and extended for longer-reach and reduced fiber count operation. In one embodiment, a given channel number can be mapped to a specific wavelength on the WDM side. Conversion in the optical domain between parallel separate waveguides and channels, and a multiplexing scheme over a single waveguide in the frequency realm is realized. This eliminates the need to perform optical-to-electrical-to-optical conversion between two different optical interconnect technologies e.g. such as OSRI and WDM.

According to an embodiment of an optical adapter, the optical adapter includes an optical coupler, a plurality of fiber optic cables and an optical wavelength conversion device. The optical coupler is operable to receive a plurality of multi-mode single-wavelength optical signals having the same frequency. The plurality of fiber optic cables are arranged in parallel and each have a first end connected to the optical coupler and the other end is coupled to the optical wavelength conversion device. The optical wavelength conversion device is operable to optically convert between the plurality of multi-mode single-wavelength optical signals at the same frequency and a plurality of single-mode optical signals at different frequencies and multiplex the plurality of single-mode optical signals at the different frequencies onto a single-mode multi-wavelength optical waveguide.

According to an embodiment of a method of optical signal conversion, the method includes: optically converting between a plurality of multi-mode single-wavelength optical signals at the same frequency and a plurality of single-mode optical signals at different frequencies; and multiplexing the plurality of single-mode optical signals at the different frequencies onto a single-mode multi-wavelength optical waveguide.

According to an embodiment of a communication system, the communication system includes an electronic circuit, a parallel optical fiber interface, an optical coupler, a plurality of short range fiber optic cables and an optical wavelength conversion device. The electronic circuit is operable to communicate electrical information. The parallel optical fiber interface is electrically coupled to the electronic circuit and operable to convert between the electrical information and a plurality of multi-mode single-wavelength optical signals having the same frequency. The optical coupler is operable to receive the plurality of multi-mode single-wavelength optical signals. The plurality of short range fiber optic cables are coupled at one end to the optical coupler and at the other end to the optical wavelength conversion device, and operable to carry the plurality of multi-mode single-wavelength optical signals. The optical wavelength conversion device is operable to optically convert between the plurality of multi-mode single-wavelength optical signals at the same frequency and a plurality of single-mode optical signals at different frequencies, and to optically multiplex the plurality of single-mode optical signals at the different frequencies onto a single-mode multi-wavelength optical waveguide.

According to an embodiment of an optical adapter at the receive side, the optical adapter includes an optical demultiplexer operable to optically separate an optical signal received over a single-mode multi-wavelength optical waveguide into a plurality of parallel optical signals at different frequencies. The optical adapter further includes a plurality of sets of photodetectors and transimpedance amplifiers operable to receive the parallel optical signals at the different frequencies and convert the parallel optical signals into corresponding electrical signals.

According to an embodiment of a method of processing a received optical signal, the method includes: optically separating an optical signal received over a single-mode multi-wavelength optical waveguide into a plurality of parallel optical signals at different frequencies; and converting the parallel optical signals into corresponding electrical signals.

Those skilled in the art will recognize additional features and advantages upon reading the following detailed description, and upon viewing the accompanying drawings.

### BRIEF DESCRIPTION OF THE FIGURES

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 illustrates a block diagram of an embodiment of electro-optical communication device.

FIG. 2 illustrates a block diagram of an embodiment of a method of optical signal conversion.

FIG. 3 illustrates a block diagram of an embodiment of a method of processing a received optical signal.

FIG. 4 illustrates a block diagram of an embodiment of an optical adapter for use with an electro-optical communication device.

### DETAILED DESCRIPTION

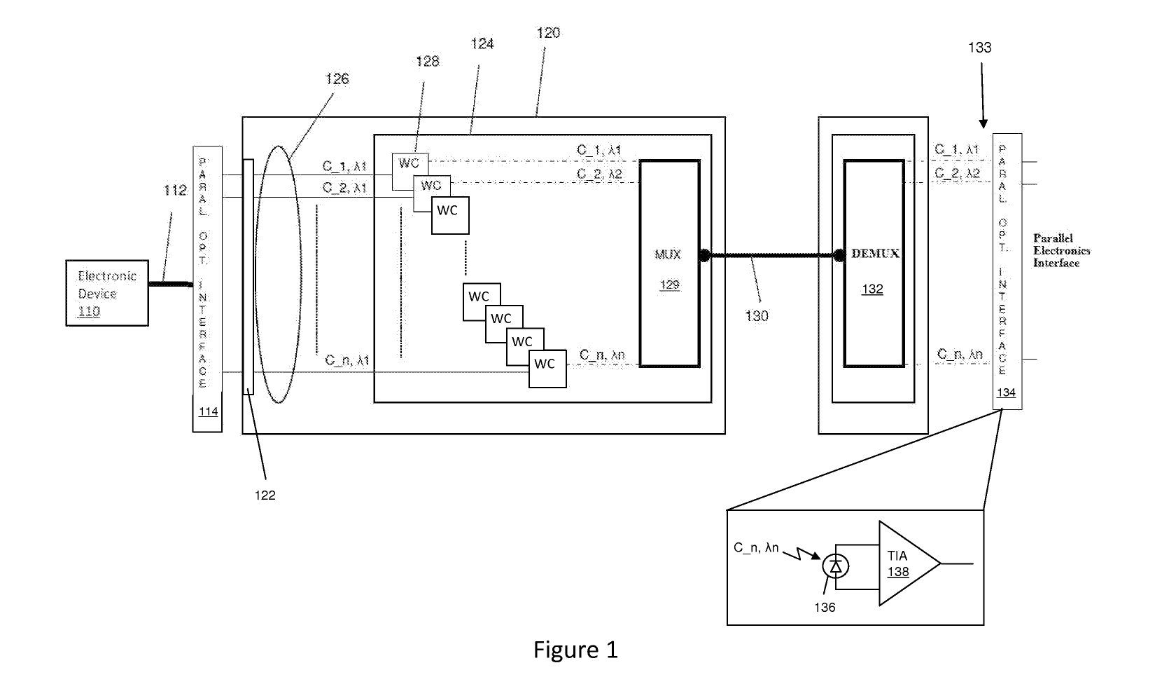

FIG. 1 illustrates an embodiment of an electro-optical communication device which may be included e.g. in a network communication chassis. The electro-optical communication device includes an electronic circuit 110 such as an ASIC (application-specific integrated circuit), processor or the like, a parallel optical fiber interface 114, and an optical adapter 120. Electrical information is communicated between the electronic circuit 110 and the parallel optical fiber interface 114 via a wire bus 112. For example the electronic circuit 110 and the parallel optical fiber interface 114 may be interconnected via one or more 10 G or 40 G I/O traces. Other types of wired connections are possible. In each case, the parallel optical fiber interface 114 converts between the electrical information and a plurality of multi-mode (MM) single-wavelength (λ) optical signals which have the same frequency.

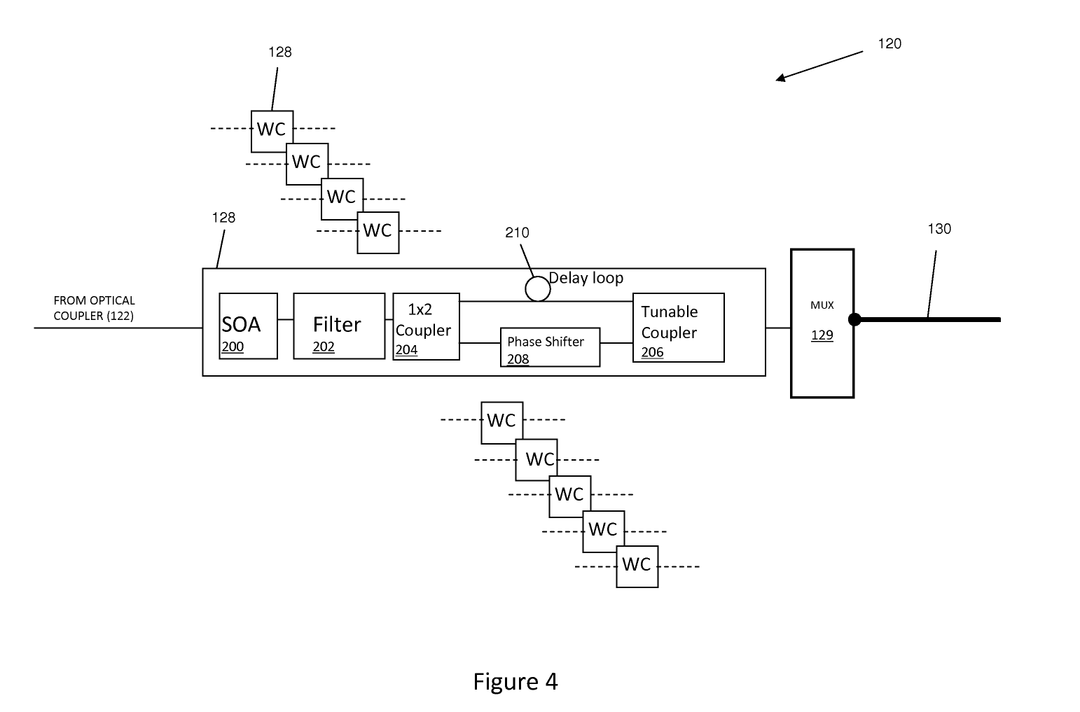

The optical adapter 120 includes an optical coupler 122 for connecting to the waveguides carrying the parallel MM single-wavelength optical signals from the optical fiber interface 114. The optical adapter 120 also includes an optical wavelength conversion device 124. The optical wavelength conversion device 124 is coupled to the optical coupler 122 via a plurality of short range fiber optic cables 126. One end of each short range fiber optic cable 126 is coupled to the optical coupler 122 and the opposing end is coupled to the wavelength conversion device 124. The short range fiber optic cables 126 carry the MM single-wavelength optical signals between the optical coupler 122 and the optical wavelength conversion device 124. Depending on the technology selected in the wavelength conversion device 124, the optical fibers 126 could also convert the optical signals from MM to single-mode (SM), which is typically the input of a semiconductor optical amplifier (e.g. the SOA 200 shown in FIG. 4). In one embodiment, the short range fiber optic cables 126 are 850 nm MM optical fibers or 1310 nm MM optical fibers. The wavelengths could also be different, such as 1060 nm or other values as long as the optical signals and fibers are MM. Each MM optical fiber 126 may have a length less than 300 m, e.g. less than 100 m and therefore is considered to be short reach. For example, the length may only be a few mm.

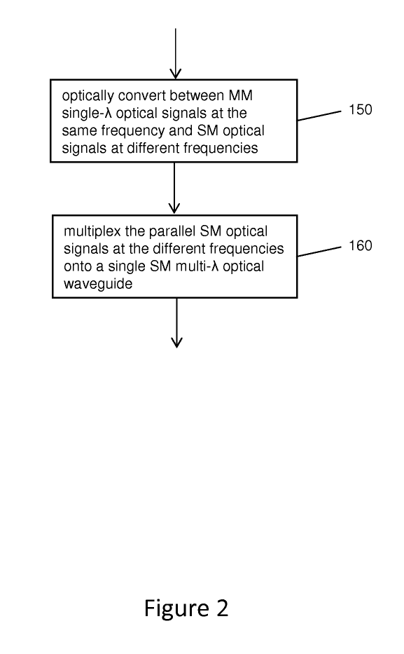

The optical wavelength conversion device 124 optically converts between the MM single-wavelength optical signals at the same frequency (λ1 in FIG. 1) and SM optical signals at different frequencies (λ1, λ2, . . . , λn), e.g. as shown in Step 150 of FIG. 2. The optical wavelength conversion device 124 also multiplexes the parallel SM optical signals at different frequencies onto a single SM multi-wavelength optical waveguide 130, e.g. as shown in Step 160 of FIG. 2. In one embodiment, the SM multi-wavelength optical waveguide is a 1310 nm SM optical fiber or a 1550 nm SM optical fiber. Other SM wavelengths may be used. In each case, the SM multi-wavelength optical waveguide 130 may have a length greater than 300 m and therefore is considered to be long reach. This way, the optical adapter 120 provides for an optical transition between two different optical interconnect technologies e.g. such as short reach single wavelength parallel optics and long reach WDM without performing optical-electrical-optical conversion.

In one embodiment, the optical wavelength conversion device 124 includes an optical wavelength converter 128 associated with each one of the MM single-wavelength optical signals and an optical multiplexer 129. The optical wavelength converters 128 are coupled to respective ones of the short range fiber optic cables 126. Each optical wavelength converter 128 optically converts the frequency of the corresponding MM single-wavelength optical signal to a different frequency so that the MM single-wavelength optical signals are communicated between the wavelength converters 128 and the optical multiplexer 129 at different frequencies and communicated between the wavelength converters 128 and the optical coupler 122 at the same frequency. One of the frequencies (e.g. λ1 in FIG. 1) can remain the same if desired. The optical multiplexer 129 multiplexes the SM optical signals at the different frequencies onto the long reach SM multi-wavelength optical waveguide 130.

Under careful selection of the wavelength used in the parallel optics engine of the parallel optical fiber interface 114, a common optical transport component such as a wavelength converter 128 can be used to assign a wavelength to a parallel channel which is pushed out over e.g. a WDM transport with better energy efficiency and system modularity. For example, the optical adapter 120 may be designed for 12 channel parallel optics in the 1550 nm C-band window. On the WDM side, a DWDM (dense WDM) wavelength converter typically converts between 64 wavelengths: λ1, λ2, . . . , λ64. However, in the case of only twelve channels (or in general some number of channels less than 64), the optical wavelength conversion device 124 instead only uses 12 channels (C_1, C_2, . . . , C_12) and assigns each channel a different wavelength or frequency (λ1, λ2, . . . , λ12) as given by C_1->λ1, C_2->λ2, . . . , C_12->λ12. The optical wavelength conversion device 124 then multiplexes the wavelengths over a single waveguide 130 toward the end point which undergoes the reverse operation.

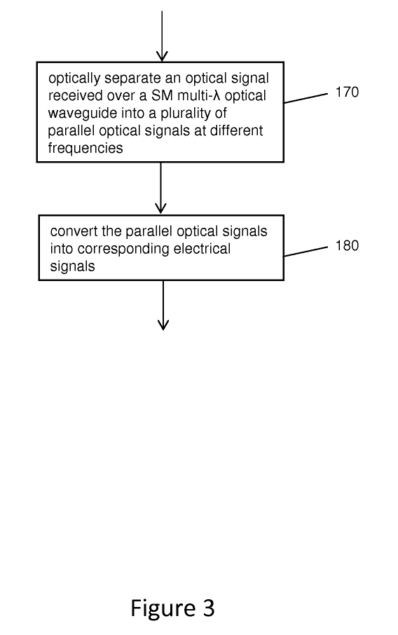

At the receiving end, an optical demultiplexer 132 demultiplexes the optical signal received over the long reach SM multi-wavelength optical waveguide 130 into corresponding recovered ones of the SM optical signals at the different frequencies (C_1, λ1; C_2, λ2; . . . ; C_12, λ12), e.g. as shown in Step 170 of FIG. 3. The SM optical signals are then input into a parallel optical interface 134 which converts the optical signals into corresponding electrical signals, e.g. as shown in Step 180 of FIG. 3. The SM optical signals could be directly input to the parallel optical interface 134, or first converted to MM optical signals before reaching the parallel optical interface 134, without affecting the wavelength assigned to each waveguide. In one embodiment, the output of the optical demultiplexer 132 is connected to the parallel optical interface 134 via a plurality of MM fibers 133. Alternatively, the optical fibers 133 connecting the optical demultiplexer 132 to the parallel optical interface 134 are SM. In either case, the parallel optical interface 134 includes a photodetector 136 and transimpedance amplifier 138 for each SM or MM optical signal. For example, the exploded view shown in FIG. 1 illustrates a photodetector 136 and a transimpedance amplifier 138 assigned to SM optical signal C_n which has frequency λn. Each set of photodetector/transimpedance amplifier 136, 138 receives the corresponding SM or MM optical signal and converts the optical signal to an electrical equivalent. The optical adapter 120 at both ends of the system can include the wavelength conversion, multiplexer and demulitplexer optical components described herein to enable full duplex operation over the long reach SM multi-wavelength optical waveguide 130.

The optical adapter 120 enables flexible multi-system designs where each system can be interconnected with large bandwidth over long distances. The optical adapter 120 is particularly well-adapted for catastrophe-resilient systems where intra-building redundancy is not sufficient. The optical adapter 120 also reduces cost because only a few separate conversion devices with more expensive WDM components are used. Relatively inexpensive and readily available OSRI technology can be used for the short reach optical connections without increasing cost by embedding WDM into the adapter 120. The optical adapter 120 also saves power by skipping optical-electrical-optical conversion by instead using all-optical wavelength conversion.

FIG. 4 illustrates an embodiment of the optical adapter 120. According to this embodiment, each wavelength converter 128 included in the wavelength conversion device 124 includes a semiconductor optical amplifier (SOA) 200. When the SOA 200 is biased with a current e.g. 200 mA, an optical input signal propagates through the active layer waveguide and emerges as an amplified output signal. All-optical wavelength conversion can be realized by utilizing the nonlinearities of the SOA 200. In one case, an OFDM (orthogonal frequency-division multiplexing) source signal electrically modulates an IM (intensity modulation) such as MZI (Mach-Zehnder interferometer) which in turn modulates lased light from a first DFB (distributed feedback) laser source at frequency w1 and lased light from a second DFB laser source at frequency w2. The source OFDM signal in light form is at frequency w3 and amplified by an EDFA (erbium doped amplifier) which in turn is fed into the SOA 200. The OFDM source and EDFA are not shown in FIG. 4 for ease of illustration only. The SOA 200 cross-modulates the first and second lased light signals at frequencies w1 and w2. The output of the SOA 200 is a fourth light wave at frequency w4, which is filtered out by a filter 202 such as a fiber Bragg grating filter. The original OFDM signal which was transmitted on frequency w3 (the input signal) is transposed to frequency w4, where w4=w1+w2−w3. Other techniques may be used to perform all-optical wavelength conversion using the nonlinearities of the SOA 200.

The filter output is provided to a 1×2 coupler 204 which splits the filter output in a direction of a tunable coupler 206 and combines or couples optical signals from the tunable coupler 206 in the opposite direction. One optical link between the 1×2 coupler 204 and the tunable coupler 206 includes a phase shifter 208 for shifting the phase of the light signal traversing this path. The other optical link between the 1×2 coupler 204 and the tunable coupler 206 includes a delay loop 210 for delaying the light signal traversing this second path. The tunable coupler 206 is optically coupled to one terminal or port of the optical multiplexer 129.

The wavelength converters 128 associated with the other MM single-wavelength optical signals have a similar architecture, perform a similar wavelength conversion and are coupled to remaining terminals or ports of the optical multiplexer 129. Other types of all-optical wavelength conversion devices may be used to optically convert between short reach MM single-wavelength optical signals and a long reach SM multi-wavelength optical signal.

Terms such as “first”, “second”, and the like, are used to describe various elements, regions, sections, etc. and are not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

It is to be understood that the features of the various embodiments described herein may be combined with each other, unless specifically noted otherwise.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An optical adapter, comprising:
an optical coupler operable to receive a plurality of multi-mode single-wavelength optical signals having the same frequency;
a plurality of fiber optic cables arranged in parallel and each having a first end connected to the optical coupler; and
an optical wavelength conversion device coupled to the plurality of fiber optic cables at a second opposing, the optical wavelength conversion device operable to optically convert between the plurality of multi-mode single-wavelength optical signals at the same frequency and a plurality of single-mode optical signals at different frequencies and multiplex the plurality of single-mode optical signals at the different frequencies onto a single-mode multi-wavelength optical waveguide.

2. The optical adapter of claim 1, wherein the plurality of fiber optic cables comprises a plurality of 850 nm multi-mode optical fibers or a plurality of 1310 nm multi-mode optical fibers.

3. The optical adapter of claim 1, wherein the single-mode multi-wavelength optical waveguide comprises a 1310 nm single-mode optical fiber or a 1550 nm single-mode optical fiber.

4. The optical adapter of claim 1, wherein the optical wavelength conversion device comprises:
an optical multiplexer operable to multiplex the plurality of single-mode optical signals at the different frequencies onto the single-mode multi-wavelength optical waveguide; and
a plurality of optical wavelength converters coupled to the optical multiplexer, each optical wavelength converter operable to optically convert the frequency of one of the plurality of multi-mode single-wavelength optical signals to a different frequency.

5. The optical adapter of claim 4, wherein the plurality of optical wavelength converters each comprise a semiconductor optical wavelength converter.

6. The optical adapter of claim 4, wherein each optical wavelength converter is assigned to one of the different frequencies of the plurality of single-mode optical signals.

7. The optical adapter of claim 6, wherein the plurality of single-mode optical signals have twelve different frequencies and the optical adapter comprises twelve optical wavelength converters, one for each of the twelve different frequencies.

8. A method of optical signal conversion, comprising:
optically converting between a plurality of multi-mode single-wavelength optical signals at the same frequency and a plurality of single-mode optical signals at different frequencies; and
multiplexing the plurality of single-mode optical signals at the different frequencies onto a single-mode multi-wavelength optical waveguide.

9. The method of claim 8, comprising multiplexing the plurality of single-mode optical signals at the different frequencies onto the single-mode multi-wavelength optical waveguide via an optical multiplexer.

10. The method of claim 8, comprising optically converting between the plurality of multi-mode single-wavelength optical signals at the same frequency and the plurality of single-mode optical signals at the different frequencies via a plurality of optical wavelength converters.

11. The method of claim 10, comprising assigning each optical wavelength converter to one of the different frequencies of the plurality of single-mode optical signals.

12. The method of claim 11, wherein the plurality of single-mode optical signals have twelve different frequencies and a single optical wavelength converter is assigned to each one of the twelve different frequencies.

13. A communication device, comprising:
an electronic circuit operable to communicate electrical information;
a parallel optical fiber interface electrically coupled to the electronic circuit and operable to convert between the electrical information and a plurality of multi-mode single-wavelength optical signals having the same frequency;
an optical coupler operable to receive the plurality of multi-mode single-wavelength optical signals;
a plurality of short range fiber optic cables coupled at one end to the optical coupler and operable to carry the plurality of multi-mode single-wavelength optical signals; and
an optical wavelength conversion device optically coupled to the other end of the plurality of short range fiber optic cables and operable to optically convert between the plurality of multi-mode single-wavelength optical signals at the same frequency and a plurality of single-mode optical signals at different frequencies, and to optically multiplex the plurality of single-mode optical signals at the different frequencies onto a single-mode multi-wavelength optical waveguide.

14. The communication device of claim 13, wherein the optical wavelength conversion device comprises:
an optical multiplexer operable to multiplex the plurality of single-mode optical signals at the different frequencies onto the single-mode multi-wavelength optical waveguide; and
a plurality of optical wavelength converters coupled between the optical multiplexer and the plurality of short range fiber optic cables, each optical wavelength converter operable to optically convert the frequency of one of the plurality of multi-mode single-wavelength optical signals to a different frequency.

15. An optical adapter, comprising:
an optical demultiplexer operable to optically separate an optical signal received over a single-mode multi-wavelength optical waveguide into a plurality of parallel optical signals at different frequencies; and
a plurality of sets of photodetectors and transimpedance amplifiers operable to receive the parallel optical signals at the different frequencies and convert the parallel optical signals into corresponding electrical signals.

16. The optical adapter of claim 15, wherein the plurality of parallel optical signals output from the demultiplexer are multi-mode optical signals and the optical demultiplexer is coupled to the plurality of sets of photodetectors and transimpedance amplifiers via a plurality of multi-mode fibers.

17. The optical adapter of claim 15, wherein the plurality of parallel optical signals output from the demultiplexer are single-mode optical signals and the optical demultiplexer is coupled to the plurality of sets of photodetectors and transimpedance amplifiers via a plurality of single-mode fibers.

18. A method of processing a received optical signal, comprising:
optically separating an optical signal received over a single-mode multi-wavelength optical waveguide into a plurality of parallel optical signals at different frequencies; and
converting the parallel optical signals into corresponding electrical signals.

19. The method of claim 18, comprising optically separating the optical signal received over the single-mode multi-wavelength optical waveguide into a plurality of single-mode parallel optical signals at the different frequencies and converting the parallel single-mode optical signals into corresponding electrical signals.

20. The method of claim 18, comprising optically separating the optical signal received over the single-mode multi-wavelength optical waveguide into a plurality of multi-mode parallel optical signals at the different frequencies and converting the parallel multi-mode optical signals into corresponding electrical signals.
